(19) United States
(12) Patent Application Publication
(10) Pub. No.: US 2007/0202793 A1
(43) Pub. Date: Aug. 30, 2007

(54) Air Discharging Device For Motor Vehicles

(75) Inventors: Dietrich Klingler, Heubach (DE); Harald Pubrl, Stuttgart (DE); Klaus Voigt, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & CO.KG

(21) Appl. No.: 10/577,271

(22) PCT Filed: Sep. 15, 2004
(86) PCT No.: PCT/EP04/10332

§ 371 Date: Mar. 5, 2007

(30) Foreign Application Priority Data
Oct. 27, 2003 (DE) 103 50 232.7

(51) Int. Cl. B60H 1/34

(52) U.S. Cl. 454/152; 454/155

(57) ABSTRACT

The invention relates to an air discharging device (1), especially for a heating or air conditioning system of a motor vehicle. The inventive air discharging device (1) comprises a discharge nozzle (2), air flow-directing elements (4), e.g. lamellae and/or flaps, and at least one electrically triggerable actuator (6), e.g. a servo motor, a DC motor with a gear mechanism, or a stepping motor. Each actuator (6) is effectively connected to one or several air flow-directing elements (4) in such a way that the position of said air flow-directing elements (4) changes when the actuator (6) is actuated, resulting in the air flow being deflected in a selectable direction or an air flow being prevented from being discharged. The inventive air discharging device (1) allows the direction of discharge of the air flow to be adjusted or, if necessary, the air discharging device (1) to be blocked in a remote controlled manner without manual intervention.

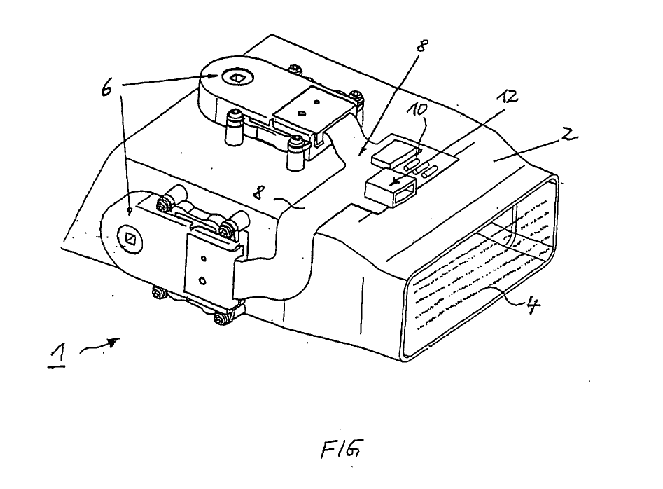

The invention relates to an air discharging device, in particular for a heating or air conditioning system for a motor vehicle.

Modern motor vehicles have a ventilation system for supplying fresh air; this is frequently combined with an air conditioning system for heating or cooling the interior of the vehicle. In this case, the air is supplied to the passenger compartment via air discharging devices which can be manually adjusted in terms of the direction and intensity of the flow of air which is emitted. To this end, air flow guide elements, usually two groups of slats and/or flaps which are arranged in the interior of the air discharging device, are provided at the mouth of the air discharging device and their position can be changed by means of knurled wheels or slides, as a result of which the direction in which the flow of air emerges is changed or the air discharging device is closed, so that no air can emerge. In this case, one group of slats is often responsible for the horizontal deflection of the flow of air and the other group is responsible for the vertical deflection of the flow of air.

In some embodiments, one of the two groups is also used to close the air discharging device; in others, a flap which is arranged in the interior of the air discharging device is used for this purpose.

The intensity of the flow of air which emerges is usually influenced by changing the rotational speed of a blower. Whereas the intensity is either adjusted manually or controlled by an automatic air conditioning system, adjustment of the direction in which the flow of air emerges and closing of the air discharging device if a flow of air is not desired in a specific case have, to date, been possible only manually. It is therefore not possible to automatically adjust the air discharging devices.

The invention is based on the object of improving an air discharging device, in particular for a heating or air conditioning system for a motor vehicle, in contrast to the air discharging device known from the prior art.

This object is achieved by an air discharging device having the features of claim 1. Advantageous refinements are the subject matter of the subclaims.

The air discharging device according to the invention comprises a discharge nozzle and at least one air flow guide element, for example slats and/or flaps, and at least one actuator, for example a servo motor, a DC motor with a gear mechanism or a stepping motor, which can be electrically actuated. Each actuator is operatively connected to one or more air flow guide elements in such a way that the position of these air flow guide elements is changed when the actuator is operated, so that the flow of air is deflected in a selected direction or a flow of air is prevented from emerging. It is possible to use the air discharging device according to the invention to adjust the direction in which the flow of air emerges in a remote-controlled manner and without manual intervention or, if required, to close the air discharging device.

It is advantageous to use the air discharging device according to the invention in vehicles with an automatic air conditioning system. One preferred embodiment of the air discharging device is particularly suitable for this purpose. The actuator is preferably arranged on the discharge nozzle, for example on the outer wall of the said discharge nozzle. As an alternative, the actuator may be in the form of an integrated module which is arranged at a suitable point on the air discharging device.

In order to use the air discharging device in an automatic air conditioning system in a vehicle, which has a bus system for example, electronics are required to actuate and control the actuators. In the preferred embodiment of the air discharging device, these electronics are fitted directly on the air discharging device. The electronics are advantageously mounted on a firm or flexible circuit carrier. When a firm circuit carrier, for example a printed circuit board, is used, the actuators can be connected to the electronics by flat ribbon cables, for example.

If a flexible circuit carrier is used, the latter may simultaneously be used as a supply line leading to the actuators. The flexibility of the circuit carrier means it is also possible to bend the said circuit carrier around the edges of the discharge nozzle given corresponding shaping and in this way also make contact with actuators which are arranged in different planes. One electronic circuit is therefore sufficient to actuate all of the actuators of the air discharging device. The number of components required is consequently drastically reduced compared to conventional configurations.

Contact can be made with the loads themselves via conventional plug connectors or by direct contact which is advantageously possible with flat conductors. Only one interface is required to communicate with a control device, for example an on-board computer or the control unit of an air conditioning system, and to supply power to all of the constituent parts of the air discharging device. Since the air discharging device according to the invention takes up only a small amount of installation space, lines can advantageously be routed using so-called MID (Molded Interconnect Device) technology, that is to say using an injected molded element with integrated interconnects and electronic components. In this case, the plastic casings, which have a corresponding layout to the circuit, are directly metallized. As a result, it is only necessary to dismantle the air discharging device but not remove the instrument panel in order to replace the electronics.

One advantage of the air discharging device according to the invention is that the actuators do not need to have their own electronics, and therefore have a low volume. The lower volume means that the choice of potential fastening locations is larger.

The use of just one electronic circuit means expenses can be saved. The use of a flexible circuit carrier, which already contains lines leading to the actuators, can save on the connectors which would otherwise be required, and this leads to an additional increase in installation space.

One exemplary embodiment of the invention is explained in greater detail with reference to a drawing. The single figure illustrates an air discharging device 1 according to the invention.

Similarly to conventional air discharging devices, the air discharging device 1 comprises a discharge nozzle 2 and air flow guide elements 4. Furthermore, the air discharging device 1 comprises actuators 6 which can be electrically actuated and a flexible circuit carrier 8 having an electronic circuit 10 and an interface 12 for actuating the electronic circuit 10. The air discharging device 1 comprises one or more actuators 6 depending on the type, size and function of the discharge nozzle 2, in particular as a function of the number and size of the air flow guide elements 4.

The actuators 6 are, for example, stepping motors which are operatively connected to one or more air flow guide elements 4 in such a way that the position of these air flow guide elements 4 is changed when the actuator 6 is operated, so that the flow of air is deflected in a selected direction or a flow of air is prevented from emerging.

The flexible circuit carrier 8, on which an electronic circuit 10 and an interface 12 for communicating with a control unit (not illustrated in any detail) are arranged, is simultaneously used as a supply line leading to the actuators 6. Some of the branches of the circuit carrier 8 which are designed to actuate the individual actuators 6 are bent around the edges of the discharge nozzle 2 in order to make contact with the individual actuators 6. The actuator 6 itself is arranged on the outside of the discharge nozzle 2. As an alternative, the actuator 6 and the discharge nozzle 2 may be in the form of an integrated module.

The electronic circuit 10 is used to actuate all of the actuators 6 which are present. The interface 12 which is likewise arranged on the circuit carrier 8 is used for the purpose of supplying power for the electronic circuit 10 and for all of the actuators 6 and also for the purpose of communication between the air discharging device 1 and the control device.

1. An air discharging device for a motor vehicle, comprising a discharge nozzle and at least one air flow guide element, wherein at least one actuator is provided and can be electrically actuated.

2. The air discharging device as claimed in claim 1, wherein the actuator is arranged on the outside of the discharge nozzle.

3. The air discharging device as claimed in claim 1, wherein the actuator is in the form of a module which is integrated in the discharge nozzle.

4. The air discharging device as claimed in claim 1, wherein an electronic circuit (10) is provided and is electrically connected to all of the actuators (6).

5. The air discharging device as claimed in claim 4, wherein the electronic circuit is arranged on a flexible circuit carrier.

6. The air discharging device as claimed in claim 5, wherein the electronic circuit is designed as an MID component, with a casing of the air discharging device being designed as a circuit carrier.

7. The air discharging device as claimed in claim 5, wherein contact is made with all of the actuators directly by means of the flexible circuit carrier.

8. The air discharging device as claimed in claim 2, wherein the actuator is in the form of a module which is integrated in the discharge nozzle.

9. The air discharging device as claimed in claim 2, wherein an electronic circuit is provided and is electrically connected to all of the actuators.

10. The air discharging device as claimed in claim 3, wherein an electronic circuit is provided and is electrically connected to all of the actuators.

11. The air discharging device as claimed in claim 6, wherein contact is made with all of the actuators directly by means of the flexible circuit carrier.
